(19) United States
(12) Patent Application Publication
(10) Pub. No.: US 2025/0033881 A1
(43) Pub. Date: Jan. 30, 2025

(54) SYSTEMS AND METHODS FOR EXCHANGING AND SELECTIVELY BUFFERING CONTAINERS OF ITEMS IN A MATERIAL HANDLING APPARATUS

(71) Applicant: OPEX Corporation, Moorestown, NJ (US)

(72) Inventor: Alexander Stevens, Moorestown, NJ (US)

(21) Appl. No.: 18/916,960

(22) Filed: Oct. 16, 2024

Related U.S. Application Data
(63) Continuation of application No. 17/679,079, filed on Feb. 23, 2022.
(63) Continuation of application No. 18/373,262, filed on Sep. 26, 2023.
(60) Provisional application No. 63/544,986, filed on Oct. 20, 2023.

(51) Int. Cl. B65G 1/04; B65G 1/06; B65G 1/10

(52) U.S. Cl. CPC B65G 1/0492; B65G 1/0421; B65G 1/065; B65G 1/10

(57) ABSTRACT

A container exchange station for a material handling system is provided. The system may include a plurality of vehicles for retrieving items from a plurality of storage locations located in one or more racks. In an embodiment, the container exchange station is configured to accommodate the vehicles so that the vehicles drive into the container exchange station and drive upwardly along a track in the container exchange station. A transfer mechanism on the vehicle cooperates with a transfer mechanism on the container exchange station to displace an item from the vehicle to a conveyor. The container exchange station may include an elevator having a plurality of elevator platforms and a plurality of elevated buffer storage locations to and from which items can be inserted and retrieved by the elevator platforms for release to a workstation when required.

### REFERENCE TO RELATED APPLICATIONS

The present application claims priority to U.S. Provisional Application No. 63/544,986, filed Oct. 20, 2023, which claims benefit to U.S. patent application Ser. No. 17/679,079 filed on Feb. 23, 2022, which claims benefit U.S. patent application Ser. No. 18/373,262 which Sep. 26, 2023. The entire disclosure of each of the foregoing applications is hereby incorporated herein by reference.

### FIELD OF THE DISCLOSURE

The present invention relates generally to systems and methods for storing, retrieving, and transferring items and, more particularly, to systems and methods which incorporate a plurality of destination areas, into and out of which containers of items are transferred, and a plurality of vehicles for carrying items to and/or from the destination areas.

### BACKGROUND OF THE DISCLOSURE

Retrieving items from storage locations and subsequently replenishing those storage locations to sustain subsequent retrieval of those items can be laborious and time consuming, especially in a system that stores thousands of items. Storing and retrieving items from thousands of storage areas requires significant labor to perform manually. For this reason, there have been proposed a variety of systems and methods for at least partially automating the retrieval of items from inventory in order that groups of such items may undergo subsequent processing. By way of example, groups of items retrieved by an automated system may, as part of an order fulfillment process, be packaged into containers for shipment to customers. Similarly, in a manufacturing process, a group of retrieved items may be subsequently transferred to a workstation and assembled together or otherwise consumed to obtain a finished or intermediate product.

Known systems for automating the retrieval and replenishment of stored inventory items have significant advantages over purely manual methods. Such advantages are particularly evident in terms of the reduction in labor costs they confer. Nonetheless, a continuing need exists for systems and methods for automating the storage, retrieval, and transfer of items in a scalable, cost effective, and space-efficient manner.

### SUMMARY OF THE INVENTION

The aforementioned need is addressed, and an advance is made in the art, by a number of inventive aspects that relate to material handling and/or storage and retrieval processes.

According to one aspect, a material handling system is provided, which includes a storage assembly dimensioned and arranged to receive and support a plurality of containers, a plurality of material handling vehicles, a first conveyor, and a container exchange station configured to exchange item-storing containers with the vehicles, to convey a first subset of the containers toward or away from the conveyor, and to accumulate a second subset of one or more containers within buffer storage locations of a buffer storage area (or zone) for subsequent conveyance to the first conveyor.

According to a further aspect of embodiments consistent with the present disclosure, the storage assembly comprises a rack which defines a plurality of vertically and/or horizontally spaced storage locations. In embodiments, the storage locations are arranged in a series of vertically spaced rows or a series of columns and are respectively dimensioned and arranged to accommodate insertion and retrieval of one or more inventory-storing containers. In some such embodiments, a track is positioned adjacent the storage locations to guide the vehicles as they traverse vertical and/or horizontal path segments to facilitate the retrieval and return of the inventory-storing containers from the storage locations defined by the rack.

According to another aspect of some embodiments consistent with the present disclosure, vehicles of the plurality of vehicles are configured to convey the containers and to retrieve one of the containers from one of the storage locations. Similarly, the vehicles may be configured to return one of the containers into one of the storage locations defined by the rack structure. To this end, a vehicle constructed according to one or more embodiments optionally includes a drive system configured to drive the vehicle along the optional track segments to a first storage location so that the vehicle may retrieve a first of the containers disposed within a rack storage location and/or buffer storage location, a rechargeable power source for providing power to the drive system. In embodiments, each vehicle further defines a surface configured to support one of the containers.

According to optional aspects of embodiments consistent with the present disclosure, the drive system of each vehicle includes one or more rotatable elements. For instance, the drive system may include a plurality of wheels or rollers, as well as both a horizontal drive system and a vertical drive system. Optionally, the horizontal drive system may be configured to drive the vehicle along a horizontal surface, while the vertical drive system may be configured to drive the vehicle vertically along the track. In embodiments incorporating such optional aspects, storage locations within the rack and/or buffer zone may be elevated with respect to the horizontal surface and the vertical drive system may be configured to drive the vehicle upwardly toward the first storage location.

In one or more embodiments consistent with the present disclosure, the first conveyor is a horizontal conveyor configured to receive the containers from the container exchange station and to convey the containers along a first horizontal path of conveyance to one more workstations. Optionally, the first horizontal path of conveyance is in a first direction. In an optional embodiment, the first horizontal conveyor defines a looped path of conveyance and comprises a first conveyor segment configured to displace the containers away from the container exchange station and a second conveyor segment configured to displace the containers to the container exchange station.

According to yet another optional aspect consistent with the present disclosure, the system further includes a central controller which includes a processor and memory, wherein the processor is configured to execute instructions stored in memory to control operation of each of the plurality of vehicles. Optionally, the processor of the central controller is further configured to execute instructions stored in memory for sequencing delivery of at least one container to a first workstation so that one or more items can be removed from the at least one container within a time window of acceptable duration. The instructions for sequencing include instructions, executable by the processor during a first interval prior to the time window, for determining in a first determining step that a first container disposed within the rack requires buffer storage at a first buffer storage location to ensure one or more items stored in the first container are accessible at the first workstation within the time window; for operating a first vehicle to retrieve the first container; for transferring the first container to one of the elevator or a second conveyor operable to transfer the first conveyor to the elevator; for operating the elevator to lift the transferred first container to an elevation proximate one of the buffer storage locations; and for operating a transfer mechanism of the elevator to transfer the first container to the first buffer storage location.

According to a further optional aspect of embodiments consistent with the present disclosure, the instructions for sequencing further include instructions executable by the processor during a second interval subsequent to the first interval but prior to the time window for operating the transfer mechanism of the elevator to retrieve the first container from the first buffer storage location and to transfer the first container to the first conveyor for conveyance to the first work station to thereby enable arrival of the first container at the first workstation within the time window.

According to yet another optional aspect of embodiments consistent with the present disclosure, instructions for sequencing further include instructions executable by the processor, during a third interval encompassing the second interval but prior to the time window and of greater duration than the second interval, for determining in a second determining step that a second container disposed within the rack requires delivery to the first conveyor; for operating a second vehicle of the plurality of vehicles to retrieve the second container; and for operating a transfer mechanism of the second vehicle to transfer the second container towards the first conveyor to thereby enable delivery of the second container to the first work station during the time window.

A material handling system constructed with a further embodiment consistent with the present disclosure comprises: a plurality of storage locations vertically spaced apart from one another in a rack, each storage location of the plurality of storage locations being dimensioned and arranged to receive and support one or more containers; a track positioned adjacent the storage locations; a plurality of containers positioned in the storage locations; a plurality of vehicles respectively configured to retrieve containers, which may be containers of inventory items or themselves inventory items, from the storage locations and to convey the containers away from the storage locations, wherein each vehicle includes a drive system configured to drive the vehicle along the track to a target storage location of the plurality of storage locations and to position the vehicle to retrieve a target container from the target storage location; and a power source for providing power to the drive system, wherein a first vehicle of the plurality of vehicles is positionable by the drive system to retrieve a first of the containers from a first storage location; a first conveyor configured to receive containers delivered by the vehicles and to convey the delivered containers, in a first direction along a first conveyance path, to a workstation at which one or more items are transferrable into or out of the containers; and a container exchange station configured to receive containers from the vehicles, to direct a first subset of the containers toward the first conveyor for conveyance along the first conveyance path, and to accumulate a second subset of the containers within storage locations of an elevated buffer storage zone for subsequent conveyance to the first conveyor and workstation.

In some embodiments, the container exchange station is configured such that containers retrievable from the buffer storage locations for transfer to the first conveyor are characterized by lower retrieval latency than storage locations defined by the rack. By way of example, the buffer storage locations may have a reduced density as compared to the storage locations defined by the rack. Accordingly, in a first embodiment, the storage locations defined by the rack are characterized by a depth sufficient to accumulate multiple containers such that one or more containers within a target storage location may require extraction and relocation in order for a delivery vehicle to gain access to and retrieve a target container to be delivered to the container exchange station. Similarly, in a second embodiment, the storage locations defined by the rack may be dimensioned arranged to store multiple containers one above the others in a column such that one or more containers may require extraction and relocation in order for a delivery vehicle to gain access to and retrieve the target container. Alternatively, or in addition, the delivery paths extending between the buffer storage locations and the first conveyor may be substantially shorter than delivery paths which extend between storage locations defined by the rack and the first conveyor.

A consequence of reduced retrieval latency and./or reduced delivery path length for containers of items more frequently needed at workstation(s) is that a smaller number of delivery vehicles may be sufficient to complete the retrieval tasks needed to supply containers of less frequently needed items, particularly when a number of unload and relocate tasks may be needed to access and retrieve containers of the less frequently needed items.

In some embodiments, the container exchange system includes a second conveyor configured to displace the containers along a second conveyance path toward the first conveyor; and an elevator configured to receive containers of the second subset and to lift received respective containers of the second subset vertically toward a plurality of corresponding buffer storage locations to enable accumulation of the second subset of containers within a buffer storage zone disposed closer to the work station than the plurality of storage locations defined by the rack.

In some embodiments, the buffer storage locations of the container exchange station are arranged as a series of columns and/or vertically spaced apart rows and, optionally, a respective elevator serves the buffer storage locations of a corresponding row or column so that each elevator delivers containers to, and removal of containers from, a single row or column of buffer storage locations.

In alternative embodiments, the elevator(s) are omitted altogether and, instead, buffer storage locations of the container exchange station are implemented as respective groups of storage elements which are each dimensioned and arranged to receive one or more containers delivered by vehicle and are themselves movable along a vertical loop path as, for example, by an endless carrier, such that the need for an elevator is obviated. That is, when a particular carrier in one of the buffer storage locations is needed, the carrier elements are moved until the carrier containing the target container of needed items is in a position of alignment with the first conveyor, thereby allowing a transfer mechanism of the storage element to transfer the target container to the first conveyor.

Some embodiments of the container exchange station include an elevator comprising a plurality of platforms movable within a column, wherein each movable platform comprises a transfer mechanism and whereby the transfer mechanism is operable to displace a container from the elevator platform to the first conveyor, in the case of a presentation inventory task.

In an embodiment, the first conveyor forms a looped, horizontal conveyance path having a first leg for conveying containers from the container exchange station to a workstation and a second leg returning the containers to the container exchange station from a workstation.

In any of the foregoing embodiments, each vehicle may comprise a transfer mechanism configured to engage the containers, wherein the transfer mechanism is configured to transfer the containers between the vehicle and the storage locations in the rack and, optionally, to transfer containers from the vehicle onto one of an elevator or a conveyor of the container exchange station.

A container exchange system according to yet another embodiment consistent with the present disclosure comprises: a first conveyor defining a first conveyance path, the first conveyor being dimensioned and arranged to receive first and second subsets of containers, which may contain items of inventory or be themselves items of inventory, and to convey retrieved containers to one of an item transfer station or a workstation disposed along the conveyance path; a pass-through zone through which containers of the first subset are transferred to the first conveyor, following retrieval from a first plurality of storage locations and upon their arrival at container exchange system; a second conveyor defining a second conveyance path, the second conveyor being arranged so that a portion of the first conveyance path is transverse to the second conveyance path; a plurality of buffer storage locations defining a buffer storage zone disposed at an elevated location relative to the first and second conveyors; and at least one elevator configured to receive containers of a second subset of containers, to lift respective containers of the second subset vertically to a first elevation for transfer of containers of the second subset to corresponding buffer storage locations and accumulation of respective containers of the second subset, and for subsequently returning containers of the second subset to a second elevation for transfer of containers of the second subset to the first conveyor.

In some embodiments, buffer storage locations are arranged within the buffer storage zone of the container exchange system as at least one of a plurality of columns or a plurality of vertically spaced apart rows. In an embodiment in which the buffer storage locations are arranged as columns, the conveyor exchange system includes an elevator comprising a plurality of elevator platforms with each elevator platform being vertically movable within a corresponding column, wherein each elevator platform comprises a transfer mechanism configured to transfer containers from the elevator to the first conveyor, whereby the transfer mechanism of each elevator is operable to at least one of displace a container from the elevator to the first conveyor following retrieval of that container from a buffer storage location or to displace a container onto the elevator from the first and/or second conveyors.

In one or more embodiments, a container exchange system further comprises a microprocessor programmed to provide control signals to perform steps of: determining, in a first determining step, that a first container received at the container exchange and buffer station contains items has an association with a first attribute or contains items which have an association with the first attribute; based on the determining, operating the second conveyor to transfer the first container to the elevator; operating the elevator to lift the first container to a first elevation proximate a target buffer storage location; operating the transfer mechanism of the elevator to transfer the first container to the target buffer storage location; optionally determining, in a second determining step, that a second container received at the container exchange and buffer station one of lacks an association with a first attribute or contains items not having an association with the first attribute; and operating the second conveyor to bypass buffer storage by transferring the second container to the first conveyor via the transfer mechanism of the elevator. In one or more embodiments, the attribute is used to distinguish those containers having items stored therein which require storage in a buffer storage location from those which do not. By way of non-limiting example, items requiring buffer storage location may be required at a workstation at a high enough frequency that storing them in storage locations of a high density storage rack would necessitate a larger number of delivery vehicles to retrieve and return the containers in which they are stored.

In yet another embodiment consistent with the present disclosure, a method of suppling containers of items to at least one workstation disposed along a conveyance path, comprises determining, in a first determining step, that a first container retrieved, by a first vehicle, from a first storage location defined by a rack structure and received at a container exchange and buffer station, has an association with a first attribute or contains items having an association with the first attribute; determining, in a second determining step, that a second container retrieved, by a second vehicle, from a second storage location defined by a rack structure and received at the container exchange and buffer station lacks an association with a first attribute or contains items not having an association with the first attribute; transferring the first container to an elevator; operating the elevator to lift the first conveyor to an elevated location proximate a buffer storage location; operating a transfer mechanism of the elevator to transfer the first container to a first buffer storage location disposed at the elevated location relative to first and second conveyors; responsive to a workstation need for an item within the first container, operating the elevator to retrieve the first container from the first buffer storage location and transfer the first container from the elevator to a first conveyor; and operating the first conveyor to convey the first container to the work station.

Optionally, the method further includes operating another conveyor to bypass buffer storage by conveying the second container in a direction toward the first conveyor.

In embodiments, the attribute comprises a stored value associated with each item type stored within a container and by which a frequency of need for that item as compared to other items managed by a material handling system is determined, whereby containers of items with the attribute may be prioritized for storage within the buffer storage system.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The foregoing summary and the following detailed description of the preferred embodiments of the present invention will be best understood when read in conjunction with the appended drawings, in which:

FIG. 1 is a diagrammatic perspective view of a material handling system;

FIG. 2 is a plan view of the material handling system illustrated in FIG. 1;

FIG. 3 is an enlarged plan view of a container exchange station of the material handling system illustrated in FIG. 1;

FIG. 4 is an enlarged side view of the container exchange station illustrated in FIG. 3;

FIG. 5 is a plan view of an alternate embodiment of a container exchange station for the material handling system illustrated in FIG. 1; and

FIG. 6 is a perspective view of a vehicle of the material handling system illustrated in FIG. 1.

### DETAILED DESCRIPTION

Various embodiments of a method and apparatus for performing inventory management tasks in an inventory management system are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like may include a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference will now be made in detail to exemplary embodiments of the present invention, examples of which are illustrated in the accompanying drawings. Wherever possible, the same reference numbers will be used throughout the drawings to refer to the same or like parts.

An illustrative embodiment consistent with the present disclosure is now described in detail. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

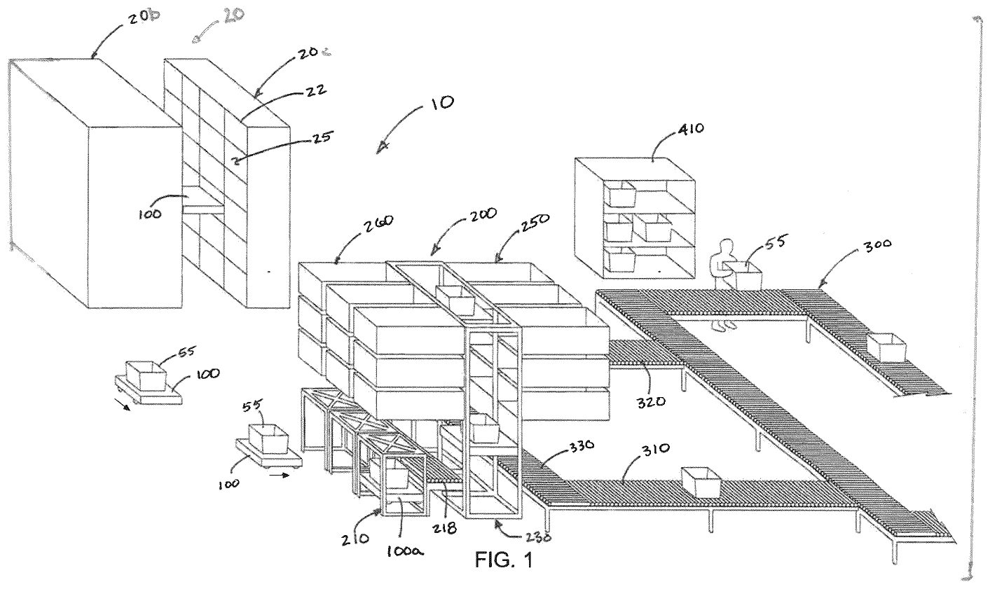

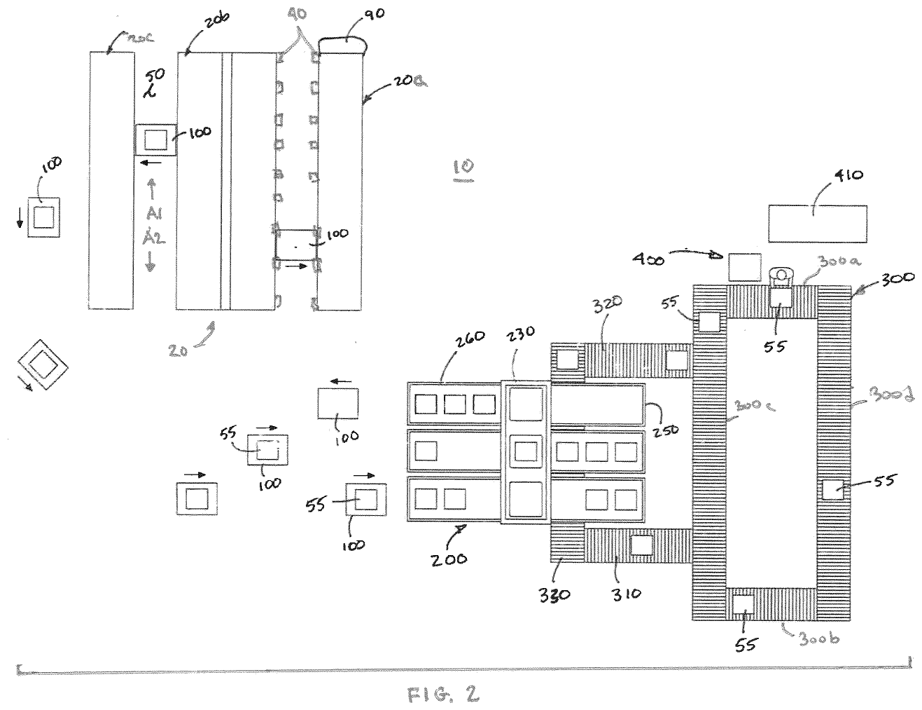

Referring now to the figures in general and to FIGS. 1 and 2 specifically, an apparatus for storing or retrieving containers of items and supplying them to one or more workstations, in accordance with embodiments of the present disclosure, is designated generally at 10. The apparatus 10 includes a storage zone 20 (FIG. 2), a container exchange (input/output) station 200, and a workstation 400 (FIG. 2).

As best seen in FIG. 2, storage zone 20 includes a first rack structure 20a, a second rack structure 20b, and a third rack structure 20c (FIG. 2). Each rack structure as rack structure 20b defines a plurality of discrete storage locations or destination areas 25 as depicted in FIG. 1. In embodiments consistent with the present disclosure, each destination area 25 is dimensioned and arranged to receive one or more containers 55 with each container 55, in turn, being dimensioned and arranged to receive and store one or more items (not shown). The destination areas 25 may be arranged in vertically spaced rows, columns, or any other space-efficient configuration which meets the requirements and needs of a given facility. In the illustrative embodiment of FIGS. 1 and 2, the destination areas 25 are arranged in vertically spaced columns 22 such that the destination areas 25 of rack structure 20b face those (not shown) of rack structure 20a and 20c, with aisle areas 50 (FIG. 2) being dimensioned and arranged between the rack structures to allow vertical and horizontal movement of vehicles 100 relative to the storage locations 25. In this regard, and as best seen in FIG. 2, track segments indicated generally at 40 are optionally aligned with and extended along respective groups of storage locations 25. In the arrangement of FIG. 2, the track segments 40 are horizontally oriented within each aisle 50 to enable the vehicles 100 to move horizontally in the direction of arrows A1 and A2 while in alternative embodiments, the track segments 40 are oriented vertically so that delivery vehicles as vehicle 100 are configured to vertically within aisles 50 and into respective positions of alignment with corresponding storage locations 25 disposed within a single column.

In embodiments consistent with the present disclosure, apparatus 10 further includes one or more mechanisms for retrieving items from the destination areas 25 defined by the racks of storage zone 20. As shown in FIGS. 1 and 2, mechanisms for retrieving items may include one or more autonomous or semi-autonomous delivery vehicles 100 that are configured to move vertically and/or horizontally within aisles 50, to retrieve containers 55 of needed items from corresponding storage locations 25, and to deliver the containers of needed items to container exchange station 200.

At container exchange station (or system) 200, some containers 55 of delivered by vehicles 100 are immediately transferable to an alternate material handling system and thereby “passed-through” that is, without buffer storage, to a processing destination as for example a replenishment workstation or an item transfer workstation. Additionally, or alternatively, containers 55 of items are transferable, at the container exchange station 200, onto vehicles 100 so that vehicles 100 can deliver the containers 55 items from the container exchange station 200 to the destination areas 25 of storage zone 20. In this way, the container exchange station 200 constitutes a mechanism for continuously storing items to and retrieving items from various storage areas of apparatus 10 and supplying such items as needed to various processing stations according to reconfigurable workflows of a given facility.

In embodiments consistent with the present disclosure, container exchange station 200 is further configured to serve as a buffer storage system and therefore includes a second storage zone dimensioned and arranged to accumulate a plurality of containers 55 of items. In embodiments, the second storage zone is an elevated buffer storage zone which includes a plurality of elevated, buffer storage locations 250, 260 for storing containers of items so that the items are readily accessible and easily transported to a workstation as workstation 400. For instance, the buffer storage locations may be used to store items that are fast moving items, such that they are ordered at a higher frequency.

The inventors herein have determined that by distinguishing between the items required more frequently at the workstation(s) as workstation 400 versus those items required less frequently, buffer storage locations as locations 250 and 260 can be prioritized in a manner that requires fewer container retrieval trips by the delivery vehicles and this, even in high storage density rack implementations, in turn allows a substantially smaller number of vehicles to perform the requisite inventory management tasks which comprise each container retrieval cycle.

Examples of preliminary inventory management tasks which must be performed by one or more delivery vehicles prior to retrieval of a target container may, in some embodiments, include movement of non-target containers out of their current storage locations so that target containers behind or underneath them can then be accessed and retrieved for delivery to the container exchange station 200. While containers storing more frequently needed items would tend to require fewer preliminary inventory management tasks due to having a higher probability of being among the most recent containers returned to rack storage locations as locations 55, the inventors have discovered that such an advantage is more than offset by a need to assign more vehicles to the retrieval tasks than are needed with a sufficient number of properly situated buffer storage locations.

As such, one or more container exchange stations 200 constructed according to embodiments of the present disclosure are used to advantageously store, retrieve, and transfer one subset of containers which are or contain one or more items having a first attribute and to pass-through another subset of containers, which are or contain one or more items which lack the first attribute, to the workstation(s) upon, for example, their delivery to the container exchange station(s) 200 by vehicles 100.

In embodiments consistent with the present disclosure, items possessing the first attribute are those items which are needed more frequently at one or more workstations as workstation 400 than other items processed by the material handling apparatus and supplied to the workstations. In embodiments, the subset of containers 55 having disposed therein one or more items possessing the first attribute are stored in elevated buffer storage locations as front buffer storage locations 250 and rear buffer storage locations 260. The buffer storage locations 250 and 260 collectively comprise an elevated buffer storage zone that is disposed sufficiently proximate the workstation(s) 400 that they can be quickly and efficiently retrieved from the buffer storage locations and transferred to the workstation(s) without requiring further use of delivery vehicles 100.

In the manner above described the container exchange station(s) 200 provide(s) rapid access to the first subset of containers 55 (and therefore the items stored within them), while the racks 20a, 20b, and 20c of storage locations 20 provide storage locations for a second subset of containers. As the storage locations 20 are further away and are characterized by higher retrieval latency, the second subset of containers continue to be retrieved and returned by the delivery vehicles 100 as needed to provide access to the items stored therein at the workstation(s) 400. It will be readily ascertained by the artisan of ordinary skill that the storage zone 20 defined by racks 20a, 20b and 20c have significantly more storage locations than the buffer storage locations of conveyor exchange station 200.

It should be understood that various items and subassemblies of the overall system can be used alone or in combination with material handling systems having different structure or operation to the system illustrated in the Figures and described below.

The material handling system 10 may include any of a variety of different systems for storing items. For instance, the material handling system may include a system that incorporates a plurality of autonomous vehicles such as the system described in U.S. Pat. No. 11,254,504. The entire description of U.S. Pat. No. 11,254,504 is hereby incorporated herein by reference.

As already mentioned in connection with FIGS. 1 and 2, the material handling system 10 may optionally incorporate one or more racks as racks 20a, 20b and 20c. Each rack may include a plurality of storage locations 25. Optionally, the storage locations may be arranged into one or more vertical columns 22. For instance, FIG. 1 illustrates a plurality of racks 20 and each rack may include a plurality of columns 22, each of which includes a plurality of storage locations 25.

The items that are handled by the system may be stored directly in the storage locations. Alternatively, the items may be stored in bins or totes 55 and the storage locations 25 may be configured to store the totes 55. Accordingly, it should be understood that unless stated otherwise in the following description, when a container is mentioned, the term container is intended to be broad enough to include a container for containing one or more items as well as simply being an item that is not necessarily contained in a bin or tote.

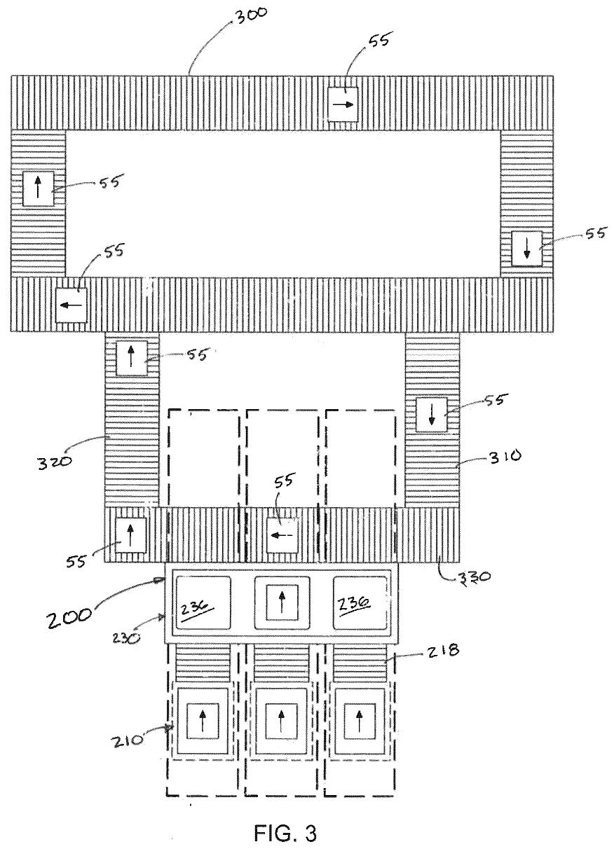

Referring to FIG. 3, the system may include a plurality of racks 20 that optionally may be positioned to form rows or aisles 50. For instance, a first rack 20a may be spaced apart from a second rack 20b so that an aisle 50 is formed between the two racks. In particular, the first rack 20a may be substantially parallel to the second rack 20b to form an aisle having a substantially uniform width. Additionally, the system may include a plurality of racks forming a plurality of aisles 50. The aisles 50 may be aligned as a series of parallel rows. However, it should be understood that if the system incorporates a plurality of racks 20, the racks may be arranged in a variety of configurations and if the system includes a plurality of aisles 50, the aisles need not be parallel.

Optionally, the system includes an automated element for storing and retrieving totes from the storage locations. One such automated element is an autonomous vehicle. For example, as discussed further below, the automated element may include a plurality of autonomous vehicles 100. Additionally, the automated vehicles 100 may be configured to retrieve the totes from the racks 20 and deliver them to the container exchange station 200 where they can be stored or transported 55 to a workstation 400 where one or more items may be removed from a tote on one of the vehicles 100.

The system 10 and/or various components of the system may be controlled by a central controller 90, such as a microcomputer. The central computer may receive signals from various elements, such as the vehicles or various sensors detecting the position of items or the vehicles. Based on the signals received, the controller controls various aspects of the system. The central controller may also store data regarding the location of various items, such as the position of the containers along a path from the rack to the workstations or the position of each vehicle. Additionally, the central controller may include data regarding the identification of items to be retrieved, such as a number of items to fill customer orders, as well as the quantity of such items. In this way, the central controller may control and coordinate the operation of various elements to schedule the retrieval and processing of a variety of items from the storage locations.

### Rack System

As noted above, the system may include one or more racks 20 having a plurality of storage locations 25. The details of an exemplary storage rack 20 are illustrated in FIGS. 1 and 2. However, it should be noted that the system may include any of a variety of elements for organizing a plurality of storage locations 25.

Each rack may include a plurality of support legs that extend substantially vertically and a plurality of brackets that extend substantially horizontally interconnecting the support legs. The brackets may be planar elements forming shelves so that the shelves form storage locations 25. Alternatively, the horizontal brackets may be L-shaped brackets that form horizontal ledges to support edges of the totes 55. The horizontal brackets may be spaced apart from one another up the height of the vertical legs to form a column 22 of vertically spaced apart storage locations 25.

As discussed above, the system may include a plurality of racks that are spaced apart to form one or more aisle 50. Optionally, a track may be positioned along one or more of the racks and the track may be configured to guide vehicles 100 vertically so that the vehicles may be conveyed up and down the column 22 to the storage locations in the column. Additionally, it may be desirable to position a first track along a rack on one side of the aisle, such as along rack 20a and a second track along a rack on the opposite side of the aisle, such as along rack 20b. The vehicles 100 may be configured so that the vehicle travels in the aisle 50 traveling vertically along a track on rack 20a while simultaneously travelling vertically along a track on rack 20b.

If the system utilizes one or more vehicles and one or more racks, the racks may be configured to allow the vehicles to travel under the racks 20 as well as being able to travel across or along any aisles that may be incorporated into the system. Referring to FIG. 2, the vehicles may follow a path that moves along one or more segments that may be parallel or transverse to the aisle. In particular, the racks may be configured to facilitate the vehicles turning horizontally underneath the racks.

### Vehicles

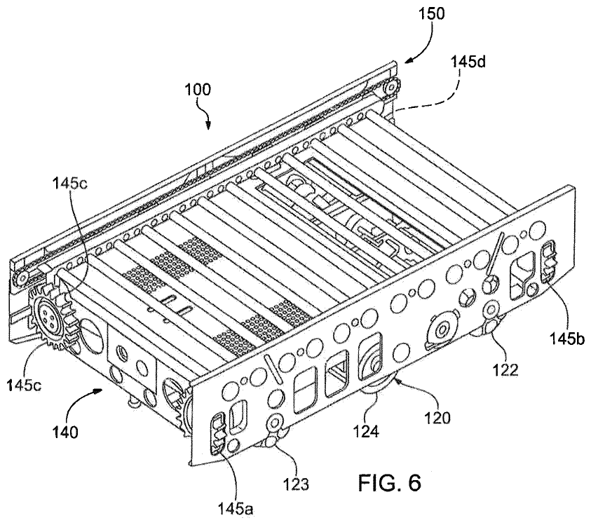

FIG. 6 illustrates details of one of the vehicles 100 that are shown in FIGS. 1-5. As noted above, if the system incorporates vehicles, the structure of the vehicle may vary. The details of an exemplary delivery vehicle 100 are disclosed in U.S. Pat. No. 11,254,504. The details of the disclosure of U.S. Pat. No. 11,254,504 are hereby incorporated herein by reference. However, it should be understood that each of the vehicle's features described in U.S. Pat. No. 11,254,504 or discussed below are optional features that may be varied or eliminated depending on the application.

The vehicles 100 may be autonomous systems that include an onboard power supply for driving the vehicle. The vehicles may also include a communication system for wirelessly receiving and transmitting control signals between each vehicle and a control element, such as a central controller. In this way, the vehicle may receive control signals regarding the location for retrieving an item and the location to which the vehicle is to deliver the item.

The central controller may include any of a variety of control mechanisms, including but not limited to a central processing unit, such as a microprocessor. Aspects of the controller may be embodied in hardware and/or in software (including firmware, resident software, micro-code, and the like), which may be generally referred to herein as a “circuit” or “module”. Furthermore, aspects of the present invention may take the form of a computer program product on a computer-usable or computer-readable storage medium having computer-usable or computer-readable program code embodied in the medium for use by or in connection with an instruction execution system. In the context of this description, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, or device. More specific examples (a list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of embodiments of the present invention may be written in an object-oriented programming language, such as Java.RTM, Smalltalk or C++, and the like. However, the computer program code for carrying out operations of embodiments of the present invention may also be written in conventional procedural programming languages, such as the “C” programming language and/or any other lower-level assembler languages. It will be further appreciated that the functionality of any or all of the program modules may also be implemented using discrete hardware components, one or more Application Specific Integrated Circuits (ASICs), or programmed Digital Signal Processors or microcontrollers.

The vehicle illustrated in FIG. 6 includes a horizontal drive assembly 120 for driving the vehicle 100 in a horizontal direction. The horizontal drive 120 may be configured to drive the vehicle along a track or along an open horizontal surface, such as a floor. For instance, one option for a horizontal drive includes a plurality of rotatable elements, such as wheels or rollers. One or more drive mechanisms may be provided for turning the rotatable elements. Additionally, the rotatable elements may turn from side to side to steer the vehicle.

Alternatively, as illustrated in FIG. 6, the vehicle may have a horizontal drive 120 formed of a plurality of rollers 122, 123, 124 that are rotatable around a first axis, such as around an axle. Additionally, the rollers 122, 123, 124 may be constrained to rotation about a single axis. For example, the horizontal drive 120 includes a pair of central rollers 124 and first and second sets of outer rollers 122, 123. The first set 122 is positioned forward of the central rollers while the second set of rollers 123 is positioned rearwardly of the central rollers 124. The outer rollers 122, 123 may include rollers spaced apart along the length of a horizontal axle so that each set of outer rollers includes a first roller on one side of the vehicle and a second roller on an opposite side of the vehicle. Additionally, each set of outer rollers may include a pair of rollers on each side of the vehicle.

As noted above, the vehicle 100 may have any of a variety of steering mechanisms for controlling the direction of travel of the vehicle. For example, an optional steering mechanism is a zero-turn mechanism that can turn the vehicle without substantially moving forwardly. Optionally, the zero-turn mechanism provides a means for turning the vehicle about a vertical axis extending through the vehicle.

In addition to the horizontal drive mechanism 120 the vehicle may also include a vertical drive mechanism 140 for driving the vehicle 100 vertically within the rack 20. In particular, as noted above, the system may include a guide mechanism such as a track 40 that is disposed adjacent the rack 20. The vertical drive mechanism 140 may be configured to cooperate with the vertical guide mechanism such as track 40 (FIG. 2) to drive the vehicle 100 vertically.

FIG. 6 illustrates an exemplary vertical drive 140 that includes a plurality of rotatable gears; however, it should be understood that the vertical drive may include any of a number of drive mechanisms for driving the vehicle vertically. The vertical drive 140 may include drive gears that rotate about a horizontal axis that is transverse the horizontal axis of rotation of the horizontal drive mechanism 120. These gears 140 may be synchronously driven. Additionally, as shown in FIG. 6, the vehicle may include two pairs of vertical drive elements that are spaced apart from one another along the length of the vehicle. In particular, optionally, the vehicle includes a first pair of vertical drive elements at a first end of the vehicle and a second pair of vertical drive elements at a second end of the vehicle.

Referring to FIGS. 1-2, the rack 20 may be configured so that a track on one rack is spaced apart from a track on a second rack a distance corresponding to the spacing between the first set of vertical drive elements and the second set of drive elements. In this way, the first vertical drive element may cooperate with the first track to drive the vehicle up the first track, while the second vertical drive element may cooperate with the second track to drive the vehicle up the second track. Optionally, the two vertical drive elements 140 are synchronously driven so that the vehicle maintains a horizontal orientation as the vehicle moves from horizontal movement to vertical movement.

The vehicle may also include an optional transfer mechanism for transferring items between the vehicle and a destination, such as a storage location. The transfer mechanism 150 may be operative to transfer an item between a platform surface of the vehicle and one of the plurality of destination areas 25. As shown in FIG. 6, the platform surface is optionally defined by the exterior surfaces of a plurality of rollers.

The transfer mechanism 150 may be any of a variety of mechanisms for loading items onto the vehicle and for unloading items from the vehicle into one of the storage areas. Additionally, the transfer mechanism 150 may be specifically tailored for a particular application. In the present instance, the transfer mechanism 150 comprises one or more displaceable element(s) configured to engage an item stored at a storage location and pull the item onto the vehicle. More specifically, in the present instance, the vehicle includes one or more displaceable element(s) configured to move toward a tote in a storage location and releasably engage the tote. After the displaceable element(s) engage the tote, each displaceable element is displaced away from the storage location, thereby pulling the tote onto the vehicle 100.

The displaceable element of the transfer mechanism may be any of a variety of items, such as a bar, rod, or another element configured to engage an item, for example, a tote. For example, referring to FIG. 6, the transfer mechanism 150 may include one or more displaceable pins. The transfer mechanism is preferably configured to cooperate with one of the totes to releasably engage the tote. For example, in the present instance, the pins are configured to mate with a recess on the tote so that the transfer mechanism can engage the tote. However, it should be recognized that the transfer mechanism may include any of a variety of elements for engaging items to be transferred onto or off of the vehicle.

### Conveying Arrangement

In one or more embodiments consistent with the present disclosure, system 10 includes an arrangement for conveying the items arriving via container exchange station 200 to and from one or more workstations, as workstation 400 shown in FIG. 2, and thereby provide a stream of containers 55 from the container exchange station 200 to the workstation(s). In the illustrative embodiment depicted in FIGS. 1-3 and 5, the conveying arrangement includes a primary conveyor indicated generally at 300, which moves containers 55 along a first conveyance path to one or more of workstations 400. In embodiments, primary conveyor 300 is of a conventional configuration and may, for example include one or more of roller conveyors or belt conveyors configured to advance the containers 55 along a horizontal conveyance path defined by respective roller surfaces or continuous belt surfaces, as the case may be, upon which the containers 55 move toward and away from the workstations 400. As such, the primary conveyor 300 may provide a generally horizontal surface for supporting items, such as the containers 55 or other items in a generally horizontal orientation.

In modified embodiments, the conveying arrangement may include a second plurality of delivery vehicles (not shown) which, owing to their limited purpose of exchanging containers between the container exchange station 200 and workstations 400, are characterized by low complexity and minimal energy consumption as compared to delivery vehicles 100 and therefore can be implemented at a comparably low cost.

In the exemplary arrangements depicted in FIGS. 1-3 and 5, primary conveyor 300 comprise one or more interconnected conveyor segments, that as mentioned already may include conveyor belts, roller beds or similar conveyor elements. The conveyor segments or elements are powered by one or more motors (not shown) that are operable to drive the conveyors and advance the containers along a path to the workstations. In this regard, primary conveyor 300 may include any of a variety of conveyor segments or legs. As best seen in FIGS. 2 and 3, primary conveyor 300 includes a first segment 300a leading away from container exchange station 200 and toward the workstation(s) 400 and a second segment 300b leading away from workstation(s) 400 and toward container exchange station 200. First and second conveyor segments 300a and 300b are connected by transverse conveyor segments 300c and 300d. The surfaces of conveyor segments 300a to 300d form, collectively, a looped first conveyance path by which the containers/items are advanced in the direction of the arrows shown in FIG. 3.

In one or more embodiments consistent with the present disclosure, and as shown in FIGS. 2-3, the container exchange station 200 is connected with the primary conveyor 300 so that containers 55 or other items may flow from the container exchange station 200 along a supplemental conveyance path to the primary conveyor 300 and, as well, flow to the conveyor exchange station from the primary conveyor 300. With continuing reference to the exemplary embodiment shown in FIGS. 2 and 3, it will be seen that the supplemental conveyance path is defined by the surface(s) of an input conveyor segment referred to hereinafter as a buffer input conveyor 310. Buffer input conveyor 310 leads from primary conveyor 300 to container exchange station 200 and enables containers to be returned either to one of the buffer storage locations or to rack storage.

Buffer input conveyor 310 may, as in the case of the segments 300a to 300d of primary conveyor 300, consist of a variety of conveyors assemblies which, in the illustrative example, define a generally horizontal conveyor path surface for transporting items as discussed above in connection with the primary conveyor 300. In one or more embodiments, buffer input conveyor 310 is configured similarly to the primary conveyor 300.

With continuing reference to the exemplary embodiment shown in FIGS. 2 and 3, it will be seen that the supplemental conveyance path is further defined by the surface(s) of an output conveyor segment referred to hereinafter as a buffer output conveyor 320. Buffer output conveyor 320 leads from container exchange station 200 to primary conveyor 300 and enables containers to be supplied to the workstation(s) 400 via primary conveyor 300 either out of one of the buffer storage locations or directly from rack storage, as the case may be. As before, buffer output conveyor 320 may be any of a variety of conveyors having or defining one or more generally horizontal surface portions for transporting items as discussed above in connection with the primary conveyor 300. Here again, buffer output conveyor 320 may be configured similarly to segments 300a to 300d of primary conveyor 300.

With particular reference to FIG. 3, and as described further below, container exchange station 200 according to one or more embodiments further include a buffer transfer conveyor 330. Buffer transfer conveyor 330 may be any of a variety of conveyors providing one or more generally horizontal surface portions which define(s) a generally horizontal conveyance path. In one or more embodiments, transfer conveyor 330 is configured substantially similar to buffer input conveyor 310 and the buffer conveyor 320.

In embodiments, buffer transfer conveyor 330 is configured to intersect one or both buffer input conveyor 310 and buffer output conveyor 320. In the embodiment depicted in FIGS. 1-3, buffer transfer conveyor 330 has a first end that intersects buffer input conveyor 310 and a second end that intersects buffer output conveyor 320. By this illustrative placement, best seen in FIG. 3, buffer transfer conveyor 330 connects buffer input conveyor 310 with buffer output conveyor 320. As such, transfer conveyor 330 forms a continuous horizontal conveyance path that is aligned with and extends between terminal surface portions of buffer input conveyor 310 and buffer output conveyor 320.

As can be seen in FIGS. 2-3, the buffer input conveyor 310, buffer transfer conveyor 330 and buffer output conveyor 320 form segments that interconnect the container exchange station 200 with the primary conveyor. In one or more embodiments, conveyors 310, 320, 330 and 300 collectively form elements of a first conveyor, wherein the purpose of the first conveyor is to exchange containers 55 between workstations 400 disposed along a first conveyance path and the buffer exchange station 200.

As noted above, the conveyors 300, 310, 320, 330 may be formed of any of a variety of conveyors. Optionally, the conveyors are formed of a plurality of conveyor segments and one or more of the segments may be formed of a plurality of parallel rollers forming a roller bed. The segments optionally intersect so that items exit from one segment onto the next segment.

One or more of the conveyors may intersect at a right angle. In such an orientation, the system may include one or more transfer mechanisms for transferring items from one of the conveyor segments to the next. Optionally, the transfer mechanism may be a right-angle transfer device.

An exemplary right-angle transfer device may be one or more conveyors belts entrained about a plurality of rollers or pulleys. The conveyors belts may be elongated in a direction opposite of the direction of travel.

The right-angle transfer device may be displaceable between a first and second position so that in a first position the right-angle transfer device is hidden or otherwise out of the path of movement of the conveyors 300, 310, 320 or 330. In this way, in the first position the right-angle transfer device does not impede movement along the conveyor, such as along the length of the conveyor. In a second position, the right-angle transfer device may impede movement along the length of the conveyor.

By way of example, the right-angle transfer device may be a conveyor that is disposed between rollers of the transfer conveyor. The right-angle transfer device may be displaceable between the first and second positions. In the first position, the right-angle transfer device may be positioned below the top surface of the rollers of the conveyor 300, 310, 320 or 330 so that items, such as containers 55 may freely move along the length of the conveyor either toward the primary conveyor 300 or toward one of the loading stations 400. In the second position, the right-angle transfer device may be positioned upwardly so that the top surface of the right-angle transfer device is raised above the conveyor 300, 310, 320, or 330. In the raised position, the right-angle transfer device is operable to displace items from one conveyor segment to an adjoining conveyor segment.

Although the transfer mechanism has been described as being a right-angle transfer device having a raised position in which the loading mechanism is operable to transfer items and a lowered position in which the transfer mechanism is stowed or retracted, it should be understood that the transfer mechanism may be any of a variety of mechanisms for displacing an item across the width of a conveyor or transferring items from one conveyor segment to the next.

### Container Exchange Station

Referring to FIGS. 1-4, system 10 includes a container exchange station 200 for receiving containers 55 from the racks 20 and either storing the containers or conveying the containers away to workstations 400. Alternatively, the container exchange station 200 may operate to transfer containers from workstations to the vehicles 100 so that the containers can be stored in the racks, as racks 20a, 20b, and 20c. In this way, the container exchange station 200 may operate as a hub for distributing containers 55 between storage racks 20 and workstations 400.

As previously described in connection with FIGS. 1 and 2, container exchange station 200 includes an elevated buffer storage zone consisting of front and rear buffer storage locations indicated generally at 250 and 260, respectively. The buffer storage locations are dimensioned and arranged to store a first subset of containers 55 according to a determined need or attribute which designates containers of the first subset as desirable to maintain in locations which make the containers available for rapid transport to the workstations 400 as opposed to retrieving the containers from storage areas 25 of racks 20a to 20c. In this way, the container exchange station 200 operates as a storage buffer between the workstations 400 and the rack storage 20. In an embodiment, the determination of whether a qualifying attribute is associated with a particular container is made by reading a bar code, RFID tag, or other indicia—upon or shortly after container arrival at an input port of container exchange station 200, and then determining whether a database entry confirms the applicability of the attribute. In some embodiments, where the container is itself an item which can be recognized via an image acquired by an imaging camera, the qualifying determination might alternatively be made by comparing the image with an image library entry in a database. Those containers for which no qualifying determination (e.g., applicability of the attribute) is made simply bypass the buffer storage zone and are transferred directly to the primary conveyor.

It will, however, be readily appreciated by the artisan of ordinary skill that the applicability of a qualifying attribute to containers being delivered by vehicles 100 to container exchange station 200 is already known to the supervisory system directing the movements and destinations of vehicles 100. That is, the location of each container in racks 20a to 20c of storage zone 20 must be known in order for the proper containers to be retrieved by the vehicles in the first place. As such, in embodiments, the determination of whether (or not) the qualifying attribute applies is typically known well before a delivery vehicle arrives at container exchange station 200. Accordingly, in one or more embodiments, delivery of containers 55 to one of ports 210 (FIGS. 1 and 3-5) of container exchange station 200 establishes, a priori, that the delivered containers are to be stored in one of the buffer storage locations.

Likewise, containers to which the attribute or need for buffer storage does not apply may be delivered by the vehicles to an alternate or pass-through port (not shown) by which such containers are passed through directly to buffer transfer conveyor 330. In one or more embodiments, a bi-directional conveyor (not shown) may be positioned between each such pass-through port and buffer transfer conveyor 330 to accommodate container transfer or, alternatively, the containers may be conveyed directly from the vehicles to buffer transfer conveyor 300.

In embodiments, containers are loaded onto vehicles at one or more locations of the first conveyance path to replenish the stock of items that are stored in racks 20a to 20c or within buffer storage locations. In such an application, conveyor system 300 may automatically convey the containers 55 either to a pass-through port of container exchange station 200 by which the containers are loaded onto vehicles 100 for return of replenished containers to rack storage locations 25 or, to one of ports 210 for return of. replenished containers to the elevated buffer storage zone defined by buffer storage locations 250 and 260. In the former case, the vehicles 100 deliver the replenished containers 55 back to racks 20a, 20b and 20c and then transfer the containers into the storage locations 25.

As noted previously, vehicles 100 may retrieve containers 55 from the storage locations 25 in racks 20a to 20c and deliver the containers to container exchange station 200. At the container exchange station 200 the container 55 may be unloaded from the vehicle 100 and stored in one of the storage locations 250, 260 in the container exchange station. Alternatively, the container 55 may be transferred to an output conveyor, which conveys the container toward the primary conveyor 300. The primary conveyor then conveys the container to a workstation where one or more items may be removed from the container or loaded into the container.

Similarly, the system may operate to convey containers 55 from one or more workstations along the primary conveyor 300 to the container exchange station 200. At the container exchange station, the container may be stored in one of the storage locations 250, 260. Alternatively, the container may be loaded onto a vehicle 100 as vehicle 100a (FIG. 1) at the conveyor exchange station and transported to a storage location 25 in one of the storage racks of storage zone 20.

In one or more embodiments, container exchange station 200 cooperates with the conveyor system 300 to complementary part of a continuous loop so that containers 55 conveyed away from container exchange station 200 are subsequently conveyed back to container exchange station 200. In that regard, conveyor system 300 may include one or more forward conveyor segments that convey containers 55 away from the container exchange station 200 and one or more return conveyor segments that convey containers toward the container exchange station 200. The workstations discussed above may be positioned along either the forward or return conveyor segments.

As earlier noted, a container exchange station 200 constructed in accordance with one or more embodiments includes one or more vehicle ports 210 where containers are transferred between the vehicles 100 as vehicle 100a (FIG. 1) and the container exchange station 200. The vehicle port 210 may include a transfer mechanism for engaging the container on the vehicle and moving it onto a receiving surface of the container exchange station. For instance, the vehicle port 210 may include one or more telescoping arms or similar mechanisms for engaging a tote or container. However, as described above, each vehicle includes a transfer mechanism 150 (FIG. 6) operable to transfer a container onto the vehicle or unload the container from the vehicle.

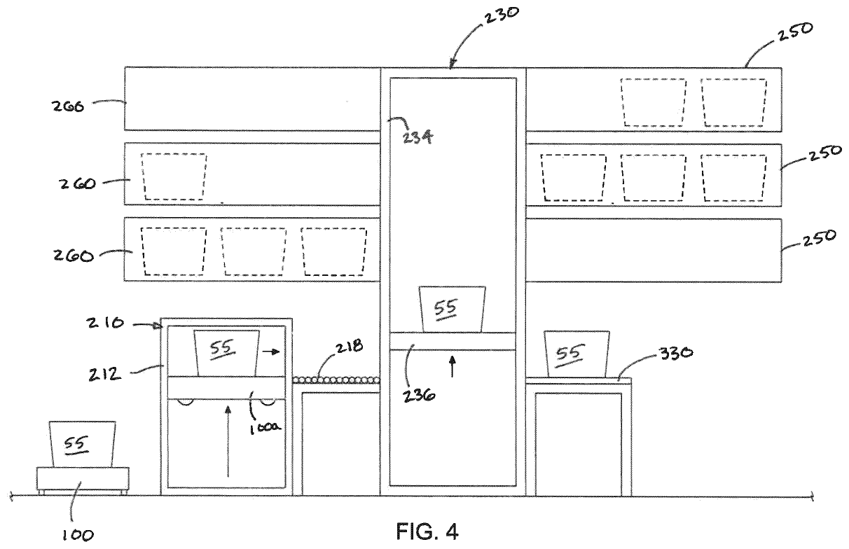

Each vehicle port 210 may be configured so that a vehicle moves upon an underlying support surface and, upon entry and alignment with a target transfer surface, transfers a container into the container exchange station 200 at ground level. Alternatively, vehicle ports 210 may include an element for lifting the vehicle vertically upwardly to an elevation which positions the container with a target transfer surface. For instance, the vehicle port may include an elevator or similar structure for lifting the vehicle. However, in the present instance, as discussed above, the vehicle 100 includes a vertical drive for lifting the vehicle vertically. Accordingly, the vertical port 210 may include a track configured to cooperate with the vertical drive 140 of the vehicle. In this way, each vehicle 100 as vehicle 100a shown in FIG. 4, is operable to drive into the vehicle port 210 and drive upwardly to an elevated level to load or unload a container.

Optionally, each vehicle port 210 includes a surface for supporting a container. The surface may be a generally horizontal surface, such as a shelf. Alternatively, as shown in FIGS. 1 and 4, vehicle ports 210 include a corresponding conveyor 218 configured to support a container delivered by a vehicle. Optionally, the conveyor 218 may be a driven conveyor, such as a conveyor belt or a powered roller bed. In this way, the conveyor may be operable to support the container and drive the container toward or away from the vehicle while the vehicle is at the vehicle port.

A mechanism 230 is provided for lifting the container from the vehicle port 210. The lifting mechanism may be any of a variety of devices, such as an elevator or climbing vehicle. Optionally, the lifting mechanism may be an elevator having a platform 236 that moves up and down in a column 234.

The container exchange station 200 may be configured so that containers are transferred directly between the elevator 230 and the vehicle 100 at the vehicle port 210. Optionally, as shown in FIG. 4, the system may be configured so that the containers are transferred between the elevator 230 and a transfer surface, such as the transfer conveyor 218.

The elevator may include a mechanism for transferring the container from the transfer conveyor 218 onto the platform 236. For example, the elevator may include one or more conveyor elements or telescoping arms for engaging the containers.

The container exchange station optionally includes a plurality of storage locations 250, 260. As shown in FIGS. 1 and 4, the container exchange station may include a first set of storage locations 250 adjacent a front side of the input station 200 and a second set of storage locations adjacent a rear side of the input station. The storage locations may be arranged in a series of rows or columns. For instance, as shown in FIG. 4, a plurality of storage locations 250, 260 may be vertically spaced from one another along the height of the container exchange station 210. Optionally, each storage location may be configured to receive a plurality of container 55. For example, each storage location 250, 260 may have a length greater than twice the length of each container 55. Optionally, as shown in FIG. 4, each storage location may have a length sufficient to accommodate 3 containers.

The container exchange station 210 may include a device for conveying containers away from the elevator 230. For instance, referring to FIGS. 3-4, the container exchange station 210 may include a transfer conveyor 330 operable to convey containers away from the elevator. Additionally, as described above, the transfer conveyor may be configured to convey containers to the elevator.

As discussed above, the elevator 230 may include a transfer mechanism operable to transfer containers between the elevator and the vehicle 100 or the input location, such as input conveyor 218. Optionally, the same mechanism is operable to transfer containers between the elevator 230 and the transfer conveyor 330. Specifically, the transfer mechanism is configured to transfer items onto the elevator from the transfer conveyor 330 or onto the transfer conveyor from the elevator. In this way, the elevator is operable to transfer containers between the vehicle port 210 and the transfer conveyor 330.

The elevator is operable to transfer containers between the storage locations 250, 260 and the vehicle port 210 or the transfer conveyor 330. Specifically, the elevator is operable to move vertically upwardly to one of the storage locations and transfer a container from one of the storage locations 250, 260 onto the elevator platform 236. The elevator is operable to move vertically downwardly with the container from the storage location to either the vehicle input or the transfer conveyor. The elevator may then operate the transfer mechanism to transfer the container in a first direction to transfer the container to a vehicle at the vehicle port. The vehicle may then move away from the vehicle port with the container and convey the container to a storage location 25 in one of the racks 20. Alternatively, the elevator transfer mechanism may transfer the container in a second direction to transfer the container to the transfer conveyor 330. The transfer conveyor 330 may transfer the container away from the elevator to one or more conveyors to deliver the container to one of the workstations 400.

Referring to FIGS. 1-4, the input/out station 200 may include a plurality of columns. Each column includes a separate vehicle port 210, elevator 230 and a series of front and rear storage locations 250, 260. The transfer conveyor 330 may extend along the length of the container exchange station 210. For instance, referring to FIG. 3, a plan view of the container exchange station is provided with the storage locations shown in dashed lines. Each of the elevators is adjacent the transfer conveyor 330 so that the transfer conveyor can receive containers from any of the elevators and transfer the container away from the container exchange station.

### Charging Assembly

The container exchange station 200 may optionally include a charging mechanism for charging the vehicles 100 at the vehicle ports 210. The charging mechanism may be connected with an electrical power source to provide a charging current to re-charge the power supply of the vehicles. For instance, optionally each vehicle includes an onboard rechargeable power source. The rechargeable power source may be a rechargeable battery. However, in the present instance, the vehicles comprise a power source that includes a plurality of ultracapacitors that can be rapidly re-charged. For example, the power source may include a plurality of supercapacitors or ultracapacitors sufficient to power the vehicle as it moves horizontally or vertically with a payload of 30-40 kilograms.

The charging mechanism may be any of a variety of elements for providing a charging current to the vehicle. For instance, in the present instance, the charging mechanism may be a charging rail that cooperates with electrical contacts on the vehicle 100.

The charging rail may comprise one or more elongated electrically conductive elements. The rail may form one or more channels or groove configured to cooperate with electrical contacts of the vehicle. For instance, the vehicle may include one or more charging contacts, such as brushes. The brushes may project outwardly from the vehicle. The brushes are oriented and configured to mate or cooperate with the charging rail. For example, the charging rail may be horizontally oriented and the charging rails may project horizontally outwardly from the rear side of the vehicle so that the brushes project into electrical contact with the charging rail when the vehicle is in the carriage.

In the foregoing description, the system is described as having a single container exchange station 200. However, it should be understood that the system may include a plurality of container exchange stations 200. Each system may include one or more conveyors for connecting the container exchange station with the primary conveyor 300. For instance, each container exchange station may include a buffer input conveyor and buffer output conveyor similar to conveyors 310, 320 described above.

Additionally, in the description above, the container exchange station 200 includes a conveyor loop that receives containers from each column and conveys the containers along a common path forming a loop that interconnects with the primary conveyor 300. However, it may be desirable to include one or more conveyors for each column in the container exchange station 200.

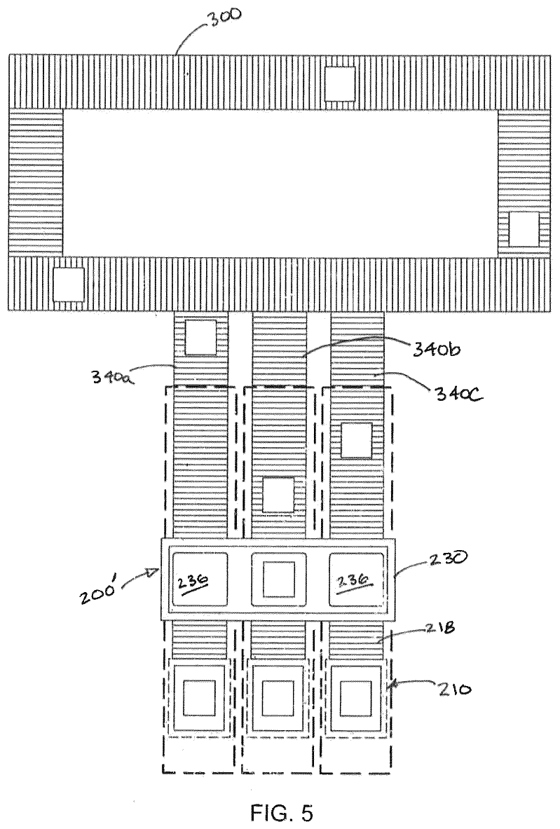

Referring now to FIG. 5, an alternative container exchange station is designated 200′. The alternate container exchange station 200′ includes a plurality of columns, each of which includes a vehicle port 210, an elevator 230 and storage locations 250, 260 the same or substantially similar to those described above in connection with the container exchange station 200. However, the manner in which containers are exchanged between the primary conveyor and the container exchange station differs. Specifically, as shown in FIG. 5, each column of the container exchange station 200′ is aligned with a corresponding transfer conveyor 340a, 340b, 340c that leads from the platforms 236 of elevator 230 to the primary conveyor 300.

Optionally, each of the transfer conveyors 340a to 340c may include a plurality of conveyors. For instance, each of transfer conveyors 340a to 340c may include a first segment defining a conveyance path for conveying containers from a platform 236 of elevator 230 to the primary conveyor 300. Additionally, each transfer conveyor may include a second segment defining a conveyance path for conveying containers from the primary conveyor 300 to a platform 236 of elevator 230. In one embodiment the first and second segments of each transfer conveyor are vertically spaced from one another so as to be stacked one upon another. In such an embodiment, the elevator lifts the container to a first height to discharge a container onto the first segment to convey the container to the primary container. A container being conveyed from the primary conveyor 300 to the elevator along the second segment of a transfer conveyor as transfer conveyor 340a may be conveyed at a second height above or below the first segment. As a container on the second segment of transfer conveyor 340a reaches the elevator, the elevator moves to the second height to retrieve the container from transfer conveyor 340a. In this way, the two segments of the transfer container form the forward and return legs of a conveyor loop between primary conveyor 300 and container exchange station 200′.

### Operation

The system 10 and the various subassemblies described above may be configured to facilitate numerous methods of operations related to material handling as described below.

The system 10 may include a plurality of autonomous vehicles 100 for delivering items to a container exchange station 200. The vehicles may be configured to drive along a horizontal pathway, such as driving along the ground. Optionally, the vehicles may drive along the ground to a storage area where a plurality of items are stored. For instance, a plurality of items may be stored in a plurality of containers, such as totes. Optionally, the totes may be stored in a plurality of racks 20 that are spaced apart forming longitudinally elongated aisles 50. The aisles may be parallel with one another.

The vehicles 100 may drive under one of the racks 20 in a direction parallel to one of the aisles 50. The vehicle 100 may drive under the rack until the vehicle reaches a destination column 22 in the rack, which is the column in which an item is to be stored or from which an item is to be retrieved.

Optionally, when the vehicle arrives at the destination column the vehicle may rotate or turn to change the direction of travel. For instance, while the vehicle is in the destination column, the vehicle may change from a direction of travel parallel to the aisle to a direction of travel transverse the aisle. Alternatively, the vehicle may drive under the rack 20 to the destination column along a path that is substantially perpendicular to the aisle. After reaching the destination column, the vehicle optionally drives perpendicular to the aisle into the aisle of the destination column.

In the aisle, the vehicle 100 optionally drives upwardly to the destination location 25 where the item is to be stored or from which the item is to be retrieved. The vehicle 100 may be raised up the column 22 by an elevator or other mechanism. However, in the present instance, the vehicle includes a vertical drive mechanism 140 operable to drive the vehicle upwardly. Additionally, the system may include a track or guide positioned adjacent the column and the vertical drive 140 of the vehicle may engage the track or guide to drive the vehicle up the column to the destination location.

Once the vehicle is raised to the destination location, an item, such as a tote 55, may be transferred between the vehicle and the destination location. For instance, the vehicle may include a transfer mechanism for transferring totes and the vehicle may actuate the transfer mechanism to transfer a tote from the vehicle to the destination location or to transfer a tote from the destination location to the vehicle.

After transferring an item between the vehicle and the destination location, the vehicle optionally drives downwardly to a horizontal path, such as the ground. The vehicle may then drive horizontally along a path that is perpendicular to the aisle.

The system may also include one or more container exchange stations 200. The system may include a method for operating an autonomous vehicle at a workstation 200. For instance, the vehicle 100 may travel along a horizontal path carrying an item, such as a tote 55, to the container exchange station 200. The vehicle may be controlled so that the vehicle is aligned with an input location 210 at the container exchange station. The container exchange station may have a plurality of input locations. Therefore, optionally, the method includes the step of determining the input location to which the vehicle is directed. After the input location is determined, the vehicle with the retrieved container is controlled to align the vehicle with the determined input location.

A first method according to one or more embodiments consistent with the present disclosure controls a plurality of vehicles to transfer items, such as totes or containers, at the container exchange station 200. A vehicle 100 controlled by an embodiment of the first method is aligned with an input location of the container exchange station 200 and then a container is transferred from the vehicle toward a container handling mechanism. Optionally, the container handling mechanism is an elevator 230 which the first method operates to lift the container.

In embodiments, the first method includes a step of transferring the container directly from the vehicle 100 to the elevator 230. Optionally, the method includes a step of unloading the container onto a container support. The container support may be a stationary element, such as a shelf. Optionally, the container support is operated by the first method to convey the container toward or away from the vehicle. For instance, the container 55 may be transferred from the vehicle to input conveyor 218. From the input conveyor 218, the container may be conveyed toward the container handling mechanism, such as the elevator 230.

In one or more embodiments, the first method includes a step of operating the vehicle to unload a container while a vehicle is disposed on a horizontal underlying surface, such as the floor of a warehouse facility, distribution center, or manufacturing operation. As depicted in FIG. 4, the first method may operate a vehicle so that it lifted off the underlying support surface at one of the input locations 210. For example, the first method may operate a vertical drive of the vehicle to drive the vehicle vertically upwardly. Accordingly, the vehicle may drive vertically upwardly at the input location. In such embodiments of the first method, the vehicle is operated to drive vertically upwardly along a track to a predetermined height at which the container is to be transferred. For example, in an embodiment, the first method operates the vehicle to drive vertically upwardly to align the container with the horizontal surface 218 onto which the container is to be unloaded. In alternative embodiments, the first method operates a lift mechanism disposed at the input location to translate the vehicle vertically together with any container thereon so that the vehicle is lifted to the elevation of an unload location.

Referring to FIGS. 3-4, the direction of flow of containers moving from the input locations 210 of the container exchange station 200 to the primary conveyor is illustrated.

The containers 55 move from the input location toward the elevators 230. The container is then loaded onto the platform 236 of the elevator 230. Optionally, the container is moved onto the elevator by actuating a transfer mechanism on the elevator. Optionally, the elevator 230 lifts the container 55 vertically to a storage location positioned vertically above the input location. The elevator aligns the platform 234 with one of the storage locations 2550, 260 and then transfers the container into one of the storage locations.

One or more methods consistent with the present disclosure include a step of transferring containers from an elevator as elevator 230 to an output mechanism configured to convey the containers toward a first conveyor which includes primary conveyor 300. In an embodiment, the elevator retrieves the container from one of the vehicles 100 at one of the input locations 210. In an alternate embodiment, the elevator 230 retrieves the container from one of the storage locations 250, 260. In either embodiment, the container is moved from the elevator to the output mechanism 330, 340. Optionally, the container is moved onto the output mechanism by actuating a transfer mechanism on the elevator.

Optionally, the method includes the step of conveying the container along a generally horizontal surface from the output mechanism 330, 340 toward one of the workstations. For instance, the container may be conveyed on top of a horizontal conveyor from the elevator toward one of the workstations.

At one of the workstations 400, an operator may retrieve one or more items from the container. For instance, the operator may remove one or more items required for an order. The step of removing one or more items from the container may be performed by a human operator. Alternatively, the operator may be an automated device operable to retrieve items from the container.

After an item is retrieved from the container, optionally the container is conveyed back to one of the container exchange stations 200. For instance, the container may be conveyed along one or more horizontal conveyor segments back to one of the container exchange stations 200.

After returning to the container exchange station, 200, the container is loaded onto the output mechanism 330 and then onto one of the elevator platforms 234. The elevator may then lift the container vertically upwardly and unload the container into one of the storage locations 250, 260. Alternatively, the container may be transferred onto one of the vehicles rather than being stored in one of the storage locations. Specifically, the container may optionally be unloaded from the elevator by actuating a transfer mechanism on the elevator. Optionally, the container is transferred onto a transfer surface 218. The container may then be transferred onto the vehicle by actuating a transfer mechanism on the vehicle.

After the container is loaded onto the vehicle, the vehicle may move away from the container exchange station 200. Optionally, the vehicle moves vertically downwardly at the loading location 210 from an elevated position to the ground floor. Once on the ground, the vehicle 100 may move along the ground toward the racks 20 to return the container to one of the storage locations 22.

A method for controlling the storage and retrieval of a plurality of items in various locations to fill a plurality of orders includes a step of determining which locations certain containers are to be stored based on the frequency with which a container is needed to fill an order. For instance, the method may include the step of identifying one or more containers that are to be stored in a first location, such as at the workstation. In one example, a specific item may be used for a significant number of the orders. Such items may be referred to as high-moving items. The system may determine that a container of the fast-moving item is to be stored at the workstation so that the item can be easily retrieved for the orders. For example, a container of the fast-moving items may be stored in a shelving unit 410 adjacent the workstation. As shown in FIG. 1, a plurality of containers of different fast-moving items may be stored at the workstation so that containers do not have to be retrieved for each order.

Additionally, the method may include the step of identifying a number of items that may be frequently required for a number of orders in a series of orders. These items may not be required for as many orders as the fast-moving items and may be referred to as medium-moving items. The method may include the step of identifying a number of medium-moving items required for a series of orders and identifying a number of containers containing the medium-moving items. The process may include the step of storing the identified containers of medium-moving items in the storage locations of the container exchange station 200.

Optionally, the process may include the step of retrieving the containers of medium moving containers from a storage system that includes a plurality of racks of containers. Optionally, the step of retrieving may include the step of driving a vehicle along the ground to the racks of containers and driving the vehicle upwardly to an elevated storage location to retrieve the container of medium-moving items. After retrieving the container of medium-moving items, the method may include the step of driving the vehicle to the container exchange station and transferring the items from the vehicle onto an elevator. The elevator may then store the medium-moving items in a storage location in the container exchange station 200. When the container of medium-moving items is needed at one of the workstations 400, the container is retrieved by the elevator and output onto the output conveyor 330, 340 and conveyed to the primary conveyor. The primary conveyor 300 may then convey the container toward the workstation. At the workstation the operator may remove one or more of the medium-moving items from the container. The container may then be returned to the container exchange station and stored in one of the storage locations 250, 260. It should be understood that the system may include a plurality of container exchange station so that when a container is described as being returned to the container exchange location it means that it is returned to any of the container exchange stations regardless of the container exchange station from which it was retrieved.

The process may also include the step of identifying a number of items as slow-moving items that are required less frequently for a series of orders than the medium moving items. Containers of the slow-moving items may be stored in the racks 20 and retrieved as needed and conveyed to the workstation from the racks 20. Specifically, when a slow-moving item is required, one of the vehicles retrieves the container of slow-moving items in a manner similar to the process described above for retrieving a container from the racks and conveys the container either directly to the workstation or to one of the container exchange stations so that the container can be loaded onto the conveyors to convey the container along the conveyors to the workstation.

By way of further illustrative example, a method of suppling containers of items to at least one workstation disposed along a conveyance path comprises determining, in a first determining step, that a first container retrieved, by a first vehicle, from a first storage location defined by a rack structure and received at a container exchange and buffer station contains items having a first attribute; transferring the first container to an elevator; operating the elevator to lift the first conveyor to a location proximate a buffer storage location; operating a transfer mechanism of the elevator to transfer the first container to a first buffer storage location of a plurality of buffer locations disposed at an elevated location relative to first and second conveyors; operating the elevator to retrieve the first container from the first buffer storage location and transfer the first container from the elevator to a first conveyor; and operating the first conveyor to convey the first container to the workstation. Optionally, the method further includes determining, in a second determining step, that a second container retrieved, by a second vehicle, from a second storage location defined by a rack structure and received at the container exchange and buffer station contains items not having an association with the first attribute; and operating a second conveyor to bypass buffer storage by conveying the second container in a direction toward the first conveyor. In one or more embodiments, the method further includes identifying items which are most frequently requested for delivery to the at least one workstation and assigning the first attribute the identified items. In an embodiment, the method further includes, in a third determining step, that a buffer storage interval applicable to the first container is expired based on exhaustion of need, at the at least one workstation, for items within the first container.

Returning to FIG. 4, a container exchange system 200 or 200′ according to embodiments consistent with the present disclosure includes a first conveyor defining a first conveyance path, the first conveyor comprising primary conveyor 300 and being dimensioned and arranged to receive subsets of containers and to convey retrieved containers toward an item transfer station or a workstation, as work station 400, disposed along the first conveyance path. Container exchange system 200 further includes a pass-through zone through which containers of the first subset are transferred to the first conveyor, following retrieval from a first plurality of storage locations and upon their arrival at container exchange system; a second conveyor defining a second conveyance path, the second conveyor being arranged so that a portion of the first conveyance path is transverse to the second conveyance path; a plurality of buffer storage locations defining a buffer storage zone disposed at an elevated location relative to the first and second conveyors; and at least one elevator configured to receive containers of a second subset of item storage containers, to lift respective containers of the second subset vertically to a first elevation for transfer of containers of the second subset to corresponding buffer storage locations and accumulation of respective containers of the second subset, and for subsequently returning containers of the second subset to a second elevation for transfer of containers of the second subset to the first conveyor.

In one or more embodiments of a container exchange system 200 (FIG. 1-3) or 200′ (FIG. 5), the buffer storage locations 250 and 260 are arranged as a plurality of vertically spaced apart rows and/or in columns. In an embodiment, each such buffer storage location is deep enough to accommodate multiple containers 55.

In an embodiment, the elevator comprises a transfer mechanism configured to exchange containers between the elevator and the second conveyor, whereby the transfer mechanism is operable to displace a container from the elevator to the second conveyor and to displace a container from the second conveyor to the elevator.

In one or more embodiments, the container exchange system further includes a central controller comprising a microprocessor programmed to provide control signals to perform steps of determining, in a first determining step, that a first container received at the container exchange and buffer station contains items having a first attribute; based on the determining, operating the second conveyor to transfer the first container to the elevator; operating the elevator to lift the first container to a first elevation proximate a target buffer storage location; operating a transfer mechanism of the elevator to transfer the first container to the target buffer storage location.

In some embodiments, the processor of the container exchange system 200 or 200′ further executes instructions stored in memory for determining, in a second determining step, that a second container received at the container exchange and buffer station lacks an association with a first attribute or contains items which lack the association with the first attribute; and operating the second conveyor to bypass buffer storage by transferring the second container to the first conveyor via the transfer mechanism of the elevator.

A material handling system which incorporates a conveyor exchange system according to the preceding embodiment comprises a plurality of storage locations vertically spaced apart from one another in a rack, each storage location of the plurality of storage locations being dimensioned and arranged to receive and support one or more containers; a plurality of containers positioned in the storage locations; a plurality of vehicles respectively configured to retrieve containers from the storage locations and to convey the containers away from the storage locations, wherein each vehicle comprises: a drive system configured to drive the vehicle to a target storage location of the plurality of storage locations and to position the vehicle to retrieve a target container from the target storage location; and a power source for providing power to the drive system, wherein a first vehicle of the plurality of vehicles is positionable by the drive system to retrieve a first of the containers from a first storage location; the material handling system further including a first conveyor configured to receive containers delivered by the vehicles and to convey the delivered containers, in a first direction along a first conveyance path, to a workstation at which one or more items are transferrable into or out of the containers; an container exchange station configured to receive containers from the vehicles, to direct a first subset of the containers toward the first conveyor for conveyance along the first conveyance path, and to accumulate a second subset of the containers within an elevated buffer storage zone for subsequent conveyance to the first conveyor and workstation.

In an embodiment, containers retrievable from the buffer storage locations for transfer to the first conveyor are characterized by lower retrieval latency than storage locations defined by the rack. Additionally, in some embodiments, delivery paths extending between the buffer storage locations and the first conveyor are substantially shorter than delivery paths extending between storage locations defined by the rack and the first conveyor.

In one or more embodiments, at least a portion of the first conveyor path is a horizontal conveyor path and wherein the container exchange station comprises: a second conveyor configured to displace the containers along a second horizontal path toward the first conveyor, wherein the second horizontal path is transverse the first horizontal path; and an elevator configured to receive containers of the second subset and to lift received respective containers of the second subset vertically toward a plurality of corresponding buffer storage locations to enable accumulation of the second subset of containers within the buffer storage zone.

From the foregoing description, it should therefore be understood that the inventive aspects disclosed herein are not limited to the particular embodiments described herein but is intended to include all changes and modifications that are within the scope and spirit of the invention as set forth in the claims.

What is claimed is:

1. A material handling system, comprising:
a plurality of storage locations vertically spaced apart from one another in a rack, each storage location of the plurality of storage locations being dimensioned and arranged to receive and support one or more containers;
a plurality of containers positioned in the storage locations;
a plurality of vehicles respectively configured to retrieve containers from the storage locations and to convey the containers away from the storage locations, wherein each vehicle comprises:
a drive system configured to drive the vehicle to a target storage location of the plurality of storage locations and to position the vehicle to retrieve a target container from the target storage location; and
a power source for providing power to the drive system, wherein a first vehicle of the plurality of vehicles is positionable by the drive system to retrieve a first of the containers from a first storage location;
a first conveyor configured to receive containers delivered by the vehicles and to convey the delivered containers, in a first direction along a first conveyance path, to a workstation at which one or more items are transferrable into or out of the containers; and
a container exchange station configured to receive containers from the vehicles, to direct a first subset of the containers toward the first conveyor for conveyance along the first conveyance path, and to accumulate a second subset of the containers within an elevated buffer storage zone for subsequent conveyance to the first conveyor and workstation.

2. The material handling system of claim 1, wherein containers retrievable from the buffer storage locations for transfer to the first conveyor are characterized by lower retrieval latency than storage locations defined by the rack.

3. The material handling system of claim 1, wherein delivery paths extending between the buffer storage locations and the first conveyor are substantially shorter than delivery paths extending between storage locations defined by the rack and the first conveyor.

4. The material handling system of claim 1, wherein at least a portion of the first conveyor path is a horizontal conveyor path and wherein the container exchange station comprises:
a second conveyor configured to displace the containers along a second horizontal path toward the first conveyor, wherein the second horizontal path is transverse the first horizontal path; and
an elevator configured to receive containers of the second subset and to lift received respective containers of the second subset vertically toward a plurality of corresponding buffer storage locations to enable accumulation of the second subset of containers within the buffer storage zone.

5. The system of claim 4 wherein the buffer storage locations are arranged within the buffer storage zone as one of a plurality of columns or a plurality of vertically spaced apart rows.

6. The system of claim 5 wherein the buffer storage locations are arranged as columns, wherein the conveyor exchange station includes an elevator having a plurality of elevator platforms with each elevator platform being vertically movable within a corresponding column, and wherein each elevator platform comprises a transfer mechanism configured to transfer containers from said each elevator platform to the first horizontal conveyor, whereby the transfer mechanism of said each elevator platform is operable to at least one of displace a container from the elevator to the first horizontal conveyor or displace a container from the second horizontal conveyor the elevator.

7. The system of claim 4 wherein the elevator comprises a transfer mechanism configured to transfer containers from said each elevator platform to the first horizontal conveyor, whereby the transfer mechanism of said each elevator platform is operable to at least one of displace a container from the elevator to the first horizontal conveyor or displace a container from the second horizontal conveyor to the elevator.

8. The system of claim 4 wherein the first conveyor forms a looped, horizontal conveyance path having a first leg dimensioned and arranged to convey containers from the container exchange station to a workstation and a second leg dimensioned and arranged to return the containers to the container exchange station from the workstation.

9. The system of claim 1 wherein each vehicle comprises a transfer mechanism configured to engage the containers, wherein the transfer mechanism is configured to transfer the containers between the vehicle and the storage locations in the rack.

10. The system of claim 6 wherein the transfer mechanism of each vehicle is configured to transfer containers from said each vehicle container to a pass-through port of the container exchange station, whereby containers of a first subset of containers are transferred to the first conveyor without first storing containers of the first set in a buffer storage location.

11. The system of claim 10, wherein the transfer mechanism of each vehicle is configured to transfer containers of the first subset directly onto the first conveyor.

12. A container exchange system comprising:
a first conveyor defining a first conveyance path, the first conveyor being dimensioned and arranged to receive first and second subsets of containers and to convey retrieved containers to one of an item transfer station or a workstation disposed along the conveyance path;
a pass-through zone through which containers of the first subset are transferred to the first conveyor, following retrieval from a first plurality of storage locations and upon their arrival at container exchange system;
a second conveyor defining a second conveyance path, the second conveyor being arranged so that a portion of the first conveyance path is transverse to the second conveyance path;
a plurality of buffer storage locations defining a buffer storage zone disposed at an elevated location relative to the first and second conveyors; and
at least one elevator configured to receive containers of a second subset of containers, to lift respective containers of the second subset vertically to a first elevation for transfer of containers of the second subset to corresponding buffer storage locations and accumulation of respective containers of the second subset, and for subsequently returning containers of the second subset to a second elevation for transfer of containers of the second subset to the first conveyor.

13. The system of claim 12, wherein the buffer storage locations are arranged within the buffer storage zone as at least one of a series of columns or vertically spaced apart rows.

14. The system of claim 13, wherein the buffer storage locations are arranged as columns, wherein the conveyor exchange system includes an elevator having a plurality of elevator platforms with each elevator being vertically movable within a corresponding column, and wherein each elevator platform comprises a transfer mechanism configured to transfer containers from said each elevator platform to the first conveyor, whereby the transfer mechanism of said each elevator platform is operable to at least one of displace a container from the elevator toward the first conveyor and displace a container from the second horizontal conveyor to the elevator.

15. The system of claim 13, wherein the elevator comprises a transfer mechanism configured to exchange containers between the elevator and the second conveyor, whereby the transfer mechanism is operable to displace a container from the elevator to the second conveyor and to displace a container from the second conveyor to the elevator.

16. The system of claim 15, further including
a central controller comprising a microprocessor programmed to provide control signals to perform steps of:
determining, in a first determining step, that a first container received at the container exchange and buffer station one of has an association with a first attribute or contains items having an association with the first attribute;
based on the determining, operating the second conveyor to transfer the first container to the elevator;
operating the elevator to lift the first container to a first elevation proximate a target buffer storage location;
operating the transfer mechanism of the elevator to transfer the first container to the target buffer storage location;
determining, in a second determining step, that a second container received at the container exchange and buffer station contains items not having an association with the first attribute; and
operating the second conveyor to bypass buffer storage by transferring the second container to the first conveyor via the transfer mechanism of the elevator.

17. A method of suppling containers of items to at least one workstation disposed along a conveyance path, comprising:
determining, in a first determining step, that a first container retrieved, by a first vehicle, from a first storage location defined by a rack structure and received at a container exchange and buffer station one of has an association with a first attribute or contains items having an association with a first attribute;
transferring the first container to an elevator;
operating the elevator to lift the first conveyor to a location proximate a buffer storage location;
operating a transfer mechanism of the elevator to transfer the first container to a first buffer storage location of a plurality of buffer locations disposed at an elevated location relative to first and second conveyors; and
operating the elevator to retrieve the first container from the first buffer storage location and transfer the first container from the elevator to a first conveyor; and
operating the first conveyor to convey the first container to the workstation.

18. The method of claim 17, further comprising:
determining, in a second determining step, that a second container retrieved, by a second vehicle, from a second storage location defined by a rack structure and received at the container exchange and buffer station contains items not having an association with the first attribute; and
operating a second conveyor to bypass buffer storage by conveying the second container in a direction toward the first conveyor.

19. The method of claim 17, further including identifying items which are most frequently requested for delivery to the at least one workstation;
assigning the first attribute to one of the identified items or the container having the identified items stored therein.

20. The method of claim 19, further including, in a third determining step, that a buffer storage interval applicable to the first container is expired based on exhaustion of need, at the at least one workstation, for items within the first container.
